(19) United States
(12) Patent Application Publication
(10) Pub. No.: US 2009/0080930 A1
(43) Pub. Date: Mar. 26, 2009

(54) IMAGING DEVICE AND ITS CONTROL METHOD

(75) Inventors: Kenichi Shinotsuka, Ome-shi (JP); Shiro Nagaoka, Ome-shi (JP); Toyokazu Aizawa, Sagamihara-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/204,335

(22) Filed: Sep. 4, 2008

(30) Foreign Application Priority Data
Sep. 21, 2007 (JP) 2007-245207

(51) Int. Cl. G03G 15/00

(52) U.S. Cl. 399/81

(57) ABSTRACT

According to an embodiment of the present invention, the imaging device comprises an image data processing module which processes acquired image data, a display module which displays image data, a storage module which stores image data, an operation input module which imparts an operation input, and a control module which controls the image capturing module, the image data processing module, the display module, and the storage module in response to the operation input, wherein the control module arranges small images of the respective representatives of a plurality of chapters which have been set to the latest moving image and also displays a large image corresponding to a small image of a representative of the first chapter as a background image when a setting state is switched from a photographing mode to a reproducing mode.

### CROSS-REFERENCE TO RELATED APPLICATIONS

This application is based upon and claims the benefit of priority from Japanese Patent Application No. 2007-245207, filed Sep. 21, 2007, the entire contents of which are incorporated herein by reference.

### BACKGROUND

1. Field

One embodiment of the invention relates to an imaging device and its control method. More specifically, the present invention relates to the improvement of chapter display and chapter management of an imaging device, and a control method therefor.

2. Description of the Related Art

A recording and reproducing device configured to record and reproduce a moving image is provided with a chapter management function. The recording and reproducing device selects a chapter item from a main menu to start the chapter management function.

When the chapter item is selected, representative images of a plurality of chapters to be set in the moving image are each arranged on a screen as a chapter menu. If the desired representative image is selected with a cursor, or the representative image number is input with a key, reproduction of the moving image of the corresponding-chapter is started. Here, if the chapter of which the reproduction has started is not the chapter which has been desired by a user, the user makes the recording and reproducing device return to the chapter menu again to select an arbitrary representative image.

However, a system, in which the user switches between the chapter menu and the reproduction of the moving image of the chapter, troubles the user to operate the device. Therefore, a technique for displaying the representative image of each chapter and the reproduced moving image of the specified chapter on the same screen at the same time has been proposed (e.g., Jpn. Pat. Appln. KOKAI Publication No. 2005-33308).

In the case in which the conventional recording and reproducing device starts the chapter management function, the conventional device has to firstly select the chapter item from the main menu. However in an imaging device (e.g., a videotape camera-recorder), selecting the chapter item from the main menu may require a great deal of time. When the user uses the imaging device, the user frequently desires to instantly confirm the scene photographed by the imaging device. In such a case, the operation itself for returning to a menu display to select the chapter item imposes a burden on the user.

### BRIEF DESCRIPTION OF THE SEVERAL VIEWS OF THE DRAWINGS

A general architecture that implements the various feature of the invention will now be described with reference of the invention will now be described with reference to the drawings. The drawings and the associated descriptions are provided to illustrate embodiments of the invention and not to limit the scope of the invention.

FIGS. 1A, 1B are explanation views depicting overviews of imaging devices with the invention applied thereto;

FIG. 2 is a view depicting an electric functional block in the imaging device of FIGS. 1A, 1B;

FIG. 3 is a view depicting a functional block in a control unit of FIG. 2;

FIG. 4 is an explanation view depicting an example of an image displayed by a chapter management function that is a feature of the invention;

FIG. 5 is an explanation view depicting another example of an image displayed by the chapter management function that is the feature of the invention;

FIG. 6 is an explanation view of an operation for setting chapters in photographing a moving image;

FIGS. 7A-7D are explanation views of operations for setting chapters to a photographed moving image; and

FIGS. 8A-8C are explanation views of operations for selecting desired chapters by the chapter management function.

### DETAILED DESCRIPTION

Various embodiments according to the invention will be described hereinafter with reference to the accompanying drawings.

According to an aspect of the invention, an object of the invention is to provide an imaging device which quickly starts up a chapter management function at an appropriate timing to significantly improve operability of a user; and to provide a control method of the imaging device. In this patent specification, the words ‘imaging’ and ‘photographing’ have the same meaning.

To achieve the object given above, an embodiment of the invention includes an image capturing module; an image data processing module which processes captured image data captured by the image capturing module; a display module which displays image data for displaying processed by the processing module; a storage module which stores the image data processed by the processing module; and an operation input module which imparts an operation input. And the embodiment further includes a control module which controls the capturing module, the processing module, the display module and the storage module in response to the operation input from the input module.

Wherein, the control module includes a chapter control module which arranges small images of each representative of a plurality of chapters that have been set on the latest moving image stored in the storage module when a setting state of an photographing mode is switched to a setting state of a reproducing mode, and also displays a large image corresponding to the small image of the representative of the first chapter as the background image. In the setting state of the photographing mode, the image data for storage has been stored in the storage module via the image data capturing module and the image data processing module.

According to the aforementioned means, when the setting state is switched from the photographing mode to the reproducing mode, since a plurality of small images of chapters and the large image of the first chapter are quickly displayed, an operation to start the chapter function is not necessary.

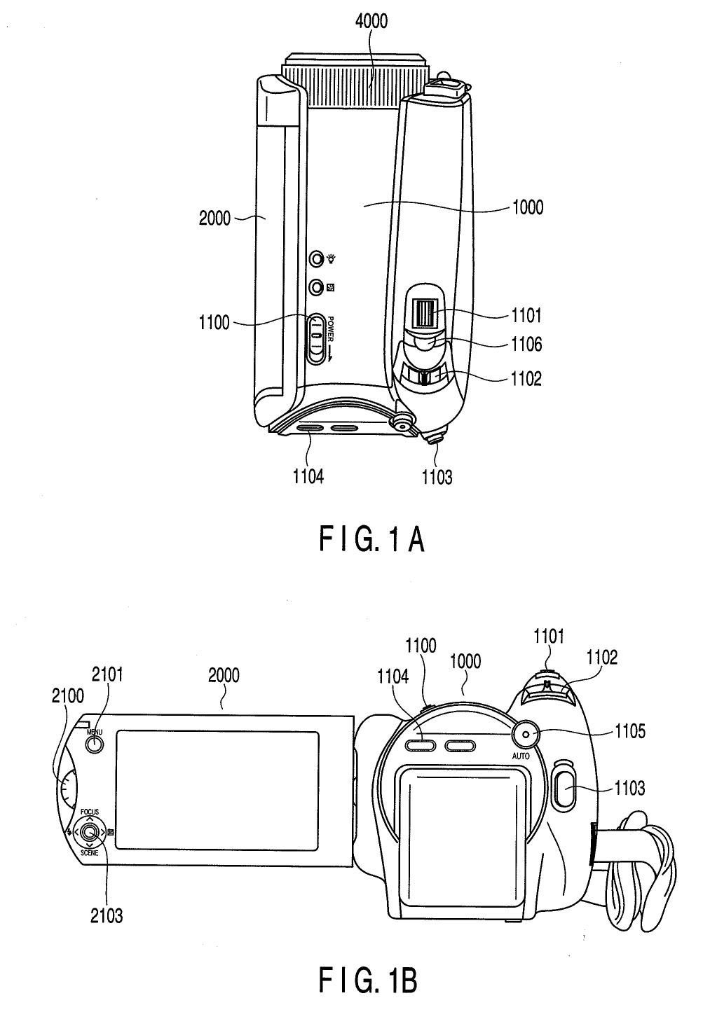

Hereinafter, concrete embodiments of the invention will be described with reference to the drawings. FIGS. 1A, 1B show overviews of imaging devices with the invention applied thereto, for example, a high-definition television (HDTV) video camera. The HDTV video camera (hereinafter referred to as video camera) may photograph a moving image and a still image.

FIG. 1A is a top view of the video camera. FIG. 1B is a rear view of the video camera. As shown in FIGS. 1A, 1B, the video camera includes an imaging device main unit 1000, a display panel 2000 and lens unit 4000.

The main unit 1000 includes a power switch 1100, a zooming lever 1101, an imaging-reproducing switching button 1102, an imaging button 1103, a chapter button 1104, and an automatic mode setting button 1105.

The power switch 1100 switches the power state of the video camera. The zooming lever 1101 adjusts a focus distance of a lens unit 4000. The imaging-reproducing switching button 1102 switches the operation mode of the video camera between a photographing mode for imaging a video and a reproducing mode for reproducing the stored image data. The imaging button 1103 executes recording the video in the case in which the operation mode of the video camera is in the photographing mode. The chapter button 1104 sets sections to the imaged data. The automatic mode setting button 1105 is for executing processing to automatically set various settings; for example, light sensitivity and brightness, for imaging the video. The numeric symbol 1106 indicates a button for still image photographing.

The display panel 2000 is a display unit of the video camera which is attached to an imaging device main unit 1000 so as to be opened and closed. The display panel 2000 is housed in a recess of the main unit 1000 normally, and is opened as shown in FIG. 1B for use. The display panel 2000 may rotate with the length direction of the display panel 2000 as the axis of rotation. The display panel 2000 has a liquid crystal monitor. The liquid crystal monitor displays the video which has been imaged with the video camera and consists of an HDTV screen with an aspect ratio of 16:9. A jog dial 2100, a menu button 2101, and a multi-function button 2103 are provided around the outer frame of the liquid crystal monitor of the display panel 2000.

The jog dial 2100 selectively operates various functions, and is composed of a rotatable dial, etc. The menu button 2101 displays a variety of menus on the liquid crystal monitor. The multi-function button 2103 includes a cross key function and may selectively operate various kinds of functions, and is movable by depressing, for example, in a vertical direction or a horizontal direction. The multi-function button 2103 includes an OK button, fixes the selective operations of various kinds of functions, and is disposed at the center of the cross key. By arranging the menu button 2101, the jog dial 2100 and the multi-function button 2103 adjacent to each other, the OK button may be easily operated after operating the jog dial 2100. The user may stably support the main unit 1000 with the right hand, support the frame of the display panel 2000 with the left hand, and arbitrarily operate the menu button 2101, the jog dial 2100 and the multi-function button 2103 with the thumb of the left hand, thus the video camera is excellent in operability.

The lens unit 4000 produces a video image using the light that enters through the imaging lens.

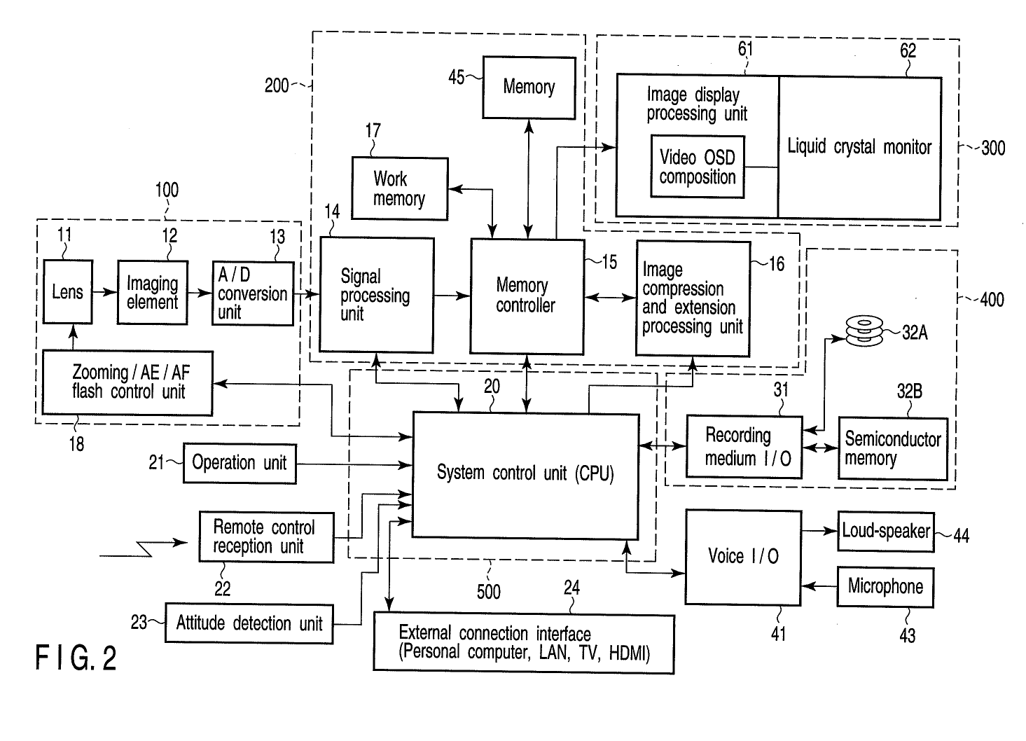

FIG. 2 shows an optical and electrical block configuration of the video camera. The video camera is provided with an image capturing unit 100, a signal processing unit 200, a display unit 300, a storage unit 400 and a control unit 500.

The image capturing unit 100 includes a lens 11, an imaging device 12, an analog-digital (A-D) conversion unit 13 and a control unit 18. An object image which has been captured from the lens 11 is formed on an image-formation surface of the imaging device 12 (e.g., a CCD imaging element). The object image is converted into a digital signal (video data) by the A-D conversion unit 13 to be input to a signal processing unit 14 at a latter stage. The control unit 18 of the imaging unit may perform zooming adjustment, automatic iris adjustment (AE), automatic focus adjustment (AF), flash control, etc.

The signal processing unit 200 is provided with a signal processing unit 14, a memory controller 15, an image compression and extension processing unit 16, a work memory 17 and a memory 45. The signal processing unit 14 performs a gamma correction, color signal separation, white balance adjustment, etc., on the digital signal of the object image from the capturing unit 100. When the photographing start operation has not been conducted in a normal photographing state, the video data from the signal processing unit 14 is input to an image display processing unit 61 via a memory controller 15. When the photographing start operation is conducted, the video data is applied with image compression (e.g., compression by MPEG/JPEG system) so as to store the video data in a storage unit 400 by means of the image compression and extension processing unit 16.

The work memory 17 is utilized for editing the video data, generating a thumbnail image, and shifting order of the images, etc. Further, the work memory 17 is utilized for editing various icons. The work memory 17 may store the image data of one screen or the image data of a plurality of screens. The video data stored on the work memory 17 is input to the screen display processing unit 61 via the memory controller 15.

The display unit 300 includes an image display processing unit 61 and a liquid crystal monitor 62. The image display processing unit 61 performs conversion processing for displaying the received video data on the liquid crystal monitor 62, performs Video OSD composition for composing various display parts (icon, etc.) and supplies the resulting video data to the liquid crystal monitor 62. The monitor 62 sequentially displays the received video data. Thereby, the image during imaging or the target object image in a standby status is displayed on the monitor 62.

The storage unit 400 has a storage medium input/output (I/O) 31. A storage medium, such as a hard disk drive (HDD) 32A and a semiconductor memory 32B are mounted on the medium I/O 31. The video data is stored on the storage medium mounted on the medium I/O in accordance with the control by the control unit 500. Based on the control by the control unit 500, if the video data stored on the storage medium mounted on the medium I/O 31 has been read, the video data is applied with the extension processing through the image compression and extension processing unit 16, and input to the image display processing unit 61 via the memory controller 15. That is, the reproduced image is displayed on the monitor 62. The recording medium is not limited to the one mentioned above, and for example, an optical disk (DVD) may be used.

The control unit 500 has a system control unit 20. The system control unit 20 controls operations of the entire video camera, and includes a CPU, a buffer memory such as a RAM for functioning as a work area of the CPU, and a program memory such as a ROM with various programs and control data to be executed by the CPU stored thereon. When the CPU executes the program stored on the program memory, the system control unit 20 achieves various functions.

The video camera is provided with an operation unit 21, a remote control reception unit 22, an attitude detection unit 23, an external interface 24, a voice I/O 41, a microphone 43, and a loud-speaker 44.

The operation unit 21 receives an operation signal from outside. The operation unit 21 is shown as a representative unit which includes various buttons or switches shown in FIG. 1. The remote control reception unit 22 receives the operation input from an external remote controller (not shown). The control unit 500 controls so as to reflect the operation input received from the operation unit 21 and the remote control reception unit 22 to the entire imaging device.

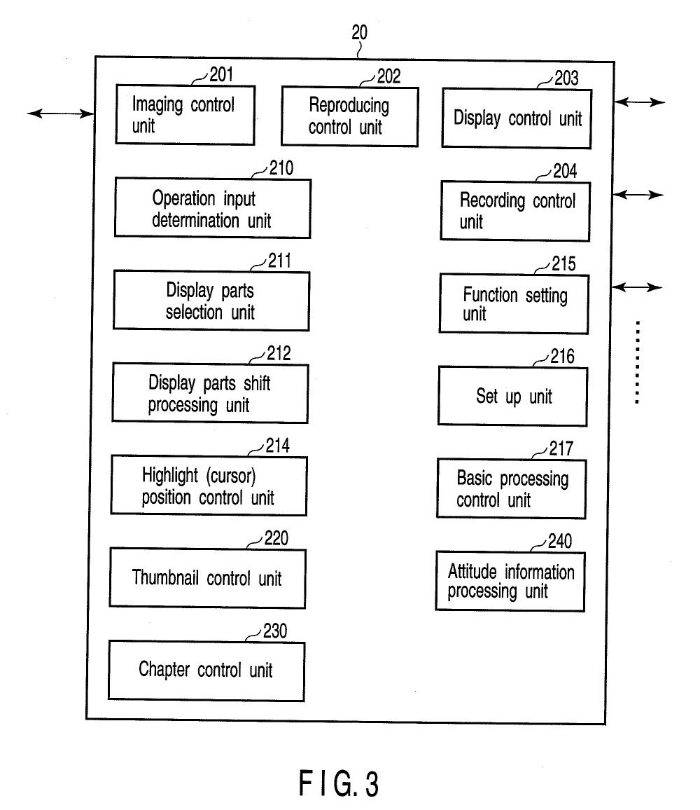

FIG. 3 shows some parts of the functions in the system control unit 20 by blocks. An imaging control unit 201 sets a photographing mode in response to the operation input to control each unit for acquiring the photographed image data. A reproduction control unit 202 sets a reproducing mode in response to the operation input. A display control unit 203 displays image data for display from the signal processing unit 200. A recording control unit 204 controls each unit so that the photographed image data is compressed by the signal processing unit 200 to be stored on the selected recording medium. An operation input determination unit 210 analyzes the operation signal input from the operation unit 21, or the remote control reception unit 22 to determine the operation signal.

A display parts selection unit 211 selects an arbitrary display part (icon, mark, etc.) to be displayed on the menu screen, etc. Various display parts are stored on the memory 45 or on the image display processing unit 61.

The display part movement processing unit 212 controls the shift and deletion of display parts in response to the operation inputs. A highlight (cursor) position control unit 214 controls a display position of a highlight position (cursor position) in response to the operation input. A function setting unit 215 is a unit for setting various functions on the imaging device in cooperation with a set-up unit 216. A basic processing control unit 217 controls basic operation functions; for example, data transfer, reading, timing setting, etc. A thumbnail control unit 220 controls creation of a thumbnail, a display output, scrolling, etc. A chapter control unit 230 has a chapter management function of creating chapters, setting representative images of the chapters, creating thumbnails of the representative images, etc. An attitude information processing unit 240 processes the information from the attitude detection unit 23, and displays a reference image to be a horizontal standard for the screen, or varies the density of the reference image according to an inclination state.

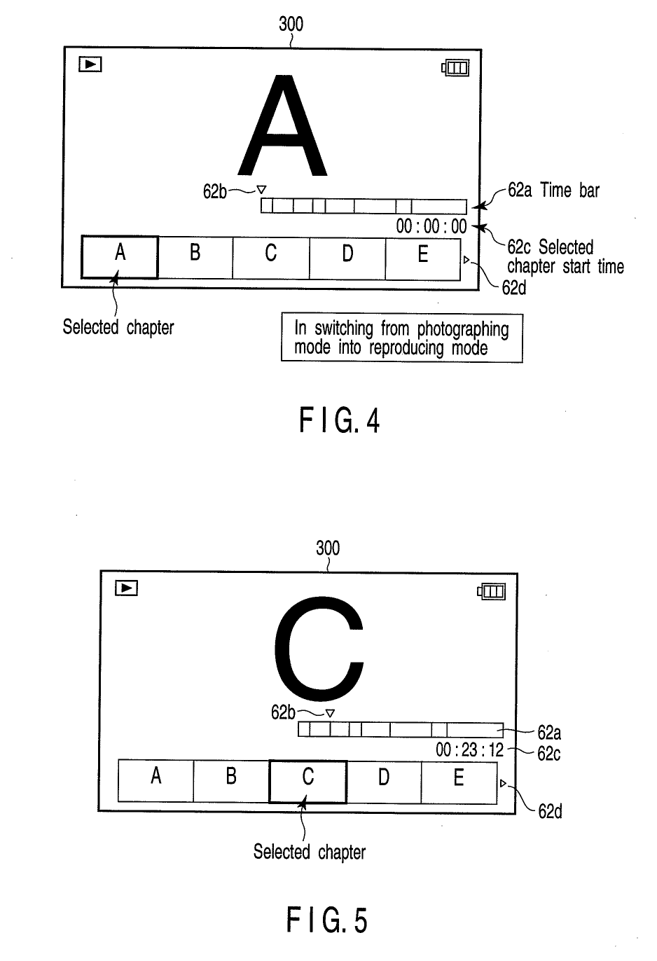

FIG. 4 shows an example of an image to be displayed on the screen of the display panel 2000 when the imaging-reproducing switching button 1102 of the imaging device is switched from the photographing mode to the reproducing mode. When the button 1102 is switched to the reproducing mode, the imaging device immediately starts the chapter control unit 230. The imaging device arranges the small images (A, B, C, D in an example shown in FIG. 4) of each representative of the plurality of chapters which have been set in the latest moving image stored on a hard disk 32A or a semiconductor memory 32B in the storage unit 400, and also displays a large image (A in an example shown in FIG. 4) corresponding to the small image of the representative of the first chapter as the background image. Here, the image which has been displayed as the background image is started to be reproduced as a moving image after the lapse of a predetermined time.

Further, at this moment, the imaging device may display a time bar 62a for visually imparting a reproduction time length of each chapter A-E on the monitor 62. Here, the chapter control unit selects an arbitrary small image in response to the operation input and may display a cursor by highlight around the selected small image. At this time, as shown in FIG. 5, the large image corresponding to the selected small image is displayed in the background. The time bar 62a displays the length of each chapter block by the length in proportion to the reproduction time length of the chapter so that the reproduction time length of each chapter may be visually understood.

Furthermore, the chapter control unit 230 may point out the spot on the time bar 62a corresponding to the selected small image with a mark 62b. The chapter control unit 230 displays a start time 62c of the chapter which is correspond to the selected small image, for the moving image. Thereby, when intending to confirm a part of the moving image, the user may visually grasp the position of the chapter of which the reproduction is desired by looking at the time bar 62a.

The following will describe the creation method of the chapters.

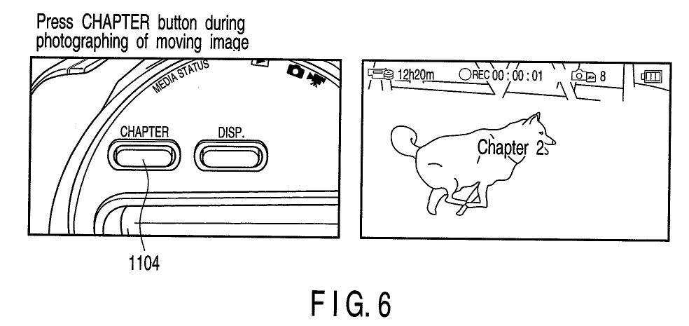

The imaging device main unit 1000, as shown in FIG. 6, is proved with a chapter button 1104. In the photographing mode, pressing the chapter button 1104 at a desired scene may set a section (a head position) of the chapter.

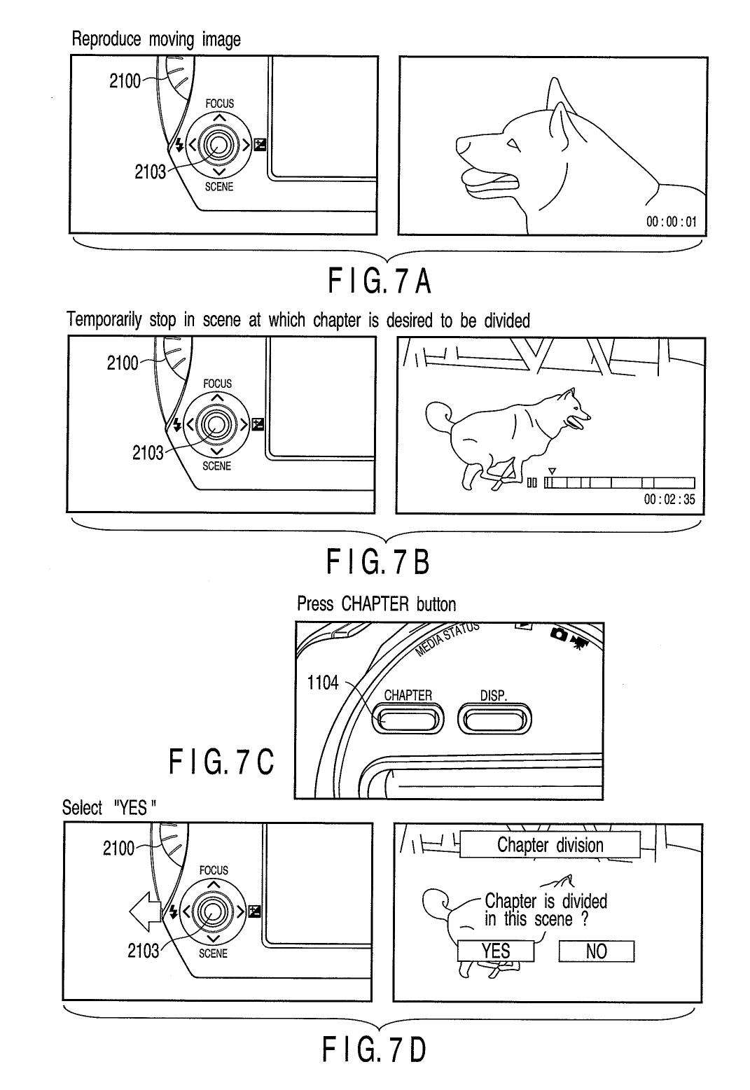

FIGS. 7A-7D show examples of the cases of creating chapters later for the moving images in which the chapters have not been created in imaging. At first, the reproducing mode is set, and when the multi-function button is pressed, the imaging device turns into the reproduction state (FIG. 7A). Here, the user presses the multi-function button to temporarily stop by means of the divided scene. When desiring to select a frame, the user may select the desired scene by turning the jog dial (FIG. 7B).

Pressing the chapter button 1104 prepares the chapter setting (FIG. 7C). Next, by operating the multi function button 1203, moving the cursor to ‘YES’, and pressing the multi function button, the user may set the chapter (FIG. 7D). Then, the next scene is reproduced as the moving image. The chapters may be set up to 20.

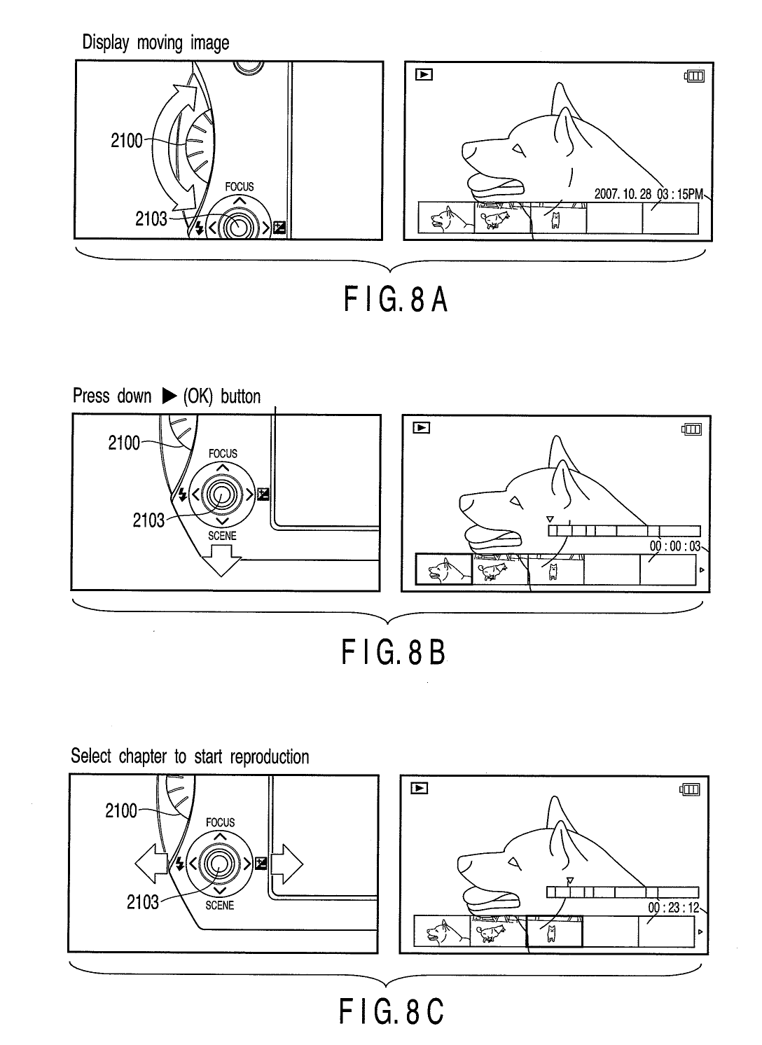

FIGS. 8A-8C shows explanation views depicting operations in reproducing the chapters. If a plurality of moving images are stored in the storage unit 400, the user may select the desired moving image by turning the jog dial 2100 after selecting the medium (FIG. 8A). At this time, the small images of the respective representatives of the plurality of chapters which have been set to the selected moving image are arranged on the liquid crystal monitor 62, and the large image corresponding to the representative small image of the first chapter is displayed as the background image. Next, pressing the multi function button in a down direction moves the cursor to the small images of the chapters (FIG. 8B). Here, pressing the multi function button in any horizontal direction enables selecting an arbitrary small image (FIG. 8C).

After deciding the chapter to be reproduced, pressing the multi function button 2103 starts the reproduction of the chapter.

As mentioned above, according to the invention, when the imaging device has been switched from the setting state of the photographing mode to the setting state of the reproducing mode, since the plurality of small images and the large image of the first chapter are displayed, the user may easily operate to start the chapter function.

It is our intention that the invention be not limited to the specific details and representative embodiments shown and described herein, and in an implementation phase, this invention may be embodied in various forms without departing from the spirit or scope of the general inventive concept thereof. Various types of the invention can be formed by appropriately combining a plurality of constituent elements disclosed in the foregoing embodiments. Some of the elements, for example, may be omitted from all the constituent elements shown in the embodiments mentioned above. Further, the constituent elements over different embodiments may be appropriately combined.

While the aforementioned embodiments have described the means for imparting the operation input as a multi function button on the left side of the display panel 2000, the invention is not limited to this method, the imaging device of the invention may be connected to a digital television receiver by using a CEC function including an HDMI device via the external interface 24. In this case, the digital television receiver functions as a monitor. Further, the imaging device may perform the same operation as that of the multi function button on the left side of the display panel 2000 by using the cross key, OK button of the remote controller for operating the digital television receiver.

The invention is effective in a control method, a program for executing the control method or a storage medium with the program stored thereon.

According to another aspect of the invention, there is provided an imaging device comprising: an image data processing unit which processes acquired image data captured by an image capturing unit; a display unit which displays image data for display processed by the image data processing unit; a storage unit which stores image data for storage processed by the image data processing unit; and an operation input unit which provides an operation input; and a control unit which controls the image capturing unit, the image data processing unit, the display unit, and the storage unit in response to the operation input from the operation input unit. Here, the invention is characterized in that the control method of the imaging device comprises: a step of setting a photographing mode in which the image data for storage is stored in the storage unit via the image data capturing unit and the image data processing unit; and a step of setting a reproducing mode in which the moving image stored in the storage unit is displayed on the display unit via the image data processing unit. When the imaging device is switched from the photographing mode to the reproducing mode, the method further comprises a step of arranging small image of the respective representatives of a plurality of chapters set to the latest moving image which has been stored in the storage unit and also displaying a large image corresponding to a small image of a representative of the first chapter as a background image.

Further, the control method is characterized in that, when the imaging device is switched from the photographing mode to the reproducing mode, the method further comprises: displaying a time bar visually providing a reproduction time length of each chapter on the display unit; pointing out a spot corresponding to the selected small image on the time bar; and selecting an arbitrary small image in response to the operation unit to display the large image corresponding to the selected small image in a background; wherein the selected small image displays a start time positioned on the moving image. Here, the invention is also effective in a program for executing each processing in the control method of the imaging device and a memory with the program stored thereon.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The various module of the systems described herein can be implemented as software applications, hardware and/or software modules, or components on one of more computers, such as servers. While the various modules are illustrated separately, they may share some or all of the same underlying logic or code.

What is claimed is:

1. An imaging device comprising:
an image capturing module configured to capture image data;
an image data processing module configured to process the captured image data;
a display to display the image data after the image data processing;
a storage module configured to store the processed image data;
an operation input module configured to accept an operation input; and
a controller configured to control the image capturing module, the image data processing module, the display, and the storage module in response to the operation input from the operation input module, wherein:
the controller is configured to arrange a reduced-size representative images of a plurality of chapters set to the latest moving image stored in the storage module and to display a full-size representative image of a first chapter as a background image when a state of the imaging device is switched from a capturing mode to a reproducing mode.

2. The imaging device of claim 1, wherein the imaging device is configured to start reproducing a moving image from a time corresponding to the full-size image after a predetermined time period has passed.

3. The imaging device of claim 1, wherein the controller is further configured to display a time bar visually indicative of a reproduction time length of each chapter on the display.

4. The imaging device of claim 1, wherein the controller is configured to select a reduced-size image in response to the operation input, to display a cursor by highlighting around the reduced-size image, and to display the full-size image corresponding to the selected reduced-size image as a background.

5. The imaging device of claim 2, wherein the chapter control module is configured to address a timing corresponding to the selected reduced-size image with a mark on the time bar.

6. The imaging device of claim 1, wherein the controller is configured to display a start time of the chapter corresponding to the selected reduced-size image of the moving image.

7. A control method of an imaging device, comprising:
capturing an image data;
processing the captured image data;
displaying the processed image data;
storing the processed image data;
accepting an operation input;
controlling the steps of the image capturing, the image data processing, the displaying, and the storing in response to the operation input;
setting a capturing mode in which the image data is stored;
setting a reproducing mode in which the stored moving image is displayed on the display;
arranging reduced-size representative images of a plurality of chapters set to the latest moving image stored; and
displaying a full-size representative image of a first chapter as a background image when a capturing mode is switched to a reproducing mode.

8. The control method of the imaging device of claim 7, further comprising steps of:
displaying a time bar visually indicating a reproduction time length of each chapter on the display;
addressing a timing corresponding to the selected reduced-size image with a mark on the time bar;
selecting a reduced-size image in response to the operation input; and
displaying a cursor by highlighting around the reduced-size image, and displaying the full-size image corresponding to the selected reduced-size image in a background;
wherein the selected reduced-size image is configured to correspond a start time on the moving image.

9. A program configured to execute each process in the control method of the imaging device of claim 8.

10. A memory configured to store a program executing each process in the control method of the imaging device of claim 8.
